(19) United States
(12) Patent Application Publication
(10) Pub. No.: US 2009/0206235 A1
(43) Pub. Date: Aug. 20, 2009

(54) METHOD AND DEVICE FOR ADJUSTING FLASH INTENSITY

(75) Inventors: QI-DA GUAN, Foshan (CN); QING-FA OU, Foshan (CN)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/147,499

(22) Filed: Jun. 27, 2008

(30) Foreign Application Priority Data
Feb. 18, 2008 (CN) 200810300345.3

(51) Int. Cl. G01J 1/32

(52) U.S. Cl. 250/205

(57) ABSTRACT

A flash intensity adjusting device includes an image capturing module, an image-displaying module, a main-image selecting module, an image partition module, a pre-flash brightness-value acquiring module, a flash-intensity calculating module, and a flash derive device. The main-image selecting module is configured for selecting a main image area from the image-displaying area. The image partition module is configured for partitioning the main image area into at least two regions. The pre-flash brightness-value acquiring module is configured for acquiring a brightness value of each region of the main image area when the flash pre-flashing. The flash-intensity calculating module is configured for calculation a mean value according to the brightness value of each region to obtain a flash intensity value of the flash. The flash drive device is configured for driving the flash unit to flash according to the flash intensity value.

### RELATED FIELD

The present invention relates to a flash intensity adjusting device, and, in particular, to a flash intensity adjusting device employed in an imaging device for adjusting flash intensity.

### BACKGROUND

In recent years, with an increase in resolution of image pickup devices such as CCD (Charge Coupled Device) or CMOS (Complementary Metal Oxide Semiconductor) image sensors, the demand for imaging devices has been rapidly increasing. A large number of products that can capture not only still images but also videos have been rolled out. Digital cameras typically include a flash unit. Conventionally, the intensity of the flash from a flash unit is set according to overall average brightness of the scene being captured. However, it is not uncommon for some areas of a scene to be brighter than other areas of the scene, therefore flash intensity set based on average brightness, may not be ideal.

It is therefore desired to provide a flash intensity adjusting device, which can overcome the above-described deficiency.

### SUMMARY

In accordance with the present invention, a flash intensity adjusting device includes an image capturing module, an image-displaying module, a main-image selecting module, an image partition module, a pre-flash brightness-value acquiring module, a flash-intensity calculating module, and a flash drive device. The flash intensity adjusting device is employed in an imaging device for adjusting flash intensity of a flash unit when highlighting an object. The image capturing module is configured for capturing an image. The image-displaying module is configured for displaying the image captured by the image capturing module. The main-image selecting module is configured for selecting a main image area from the image-displaying area. The image partition module is configured for partitioning the main image area into at least two regions. The pre-flash brightness-value acquiring module is configured for acquiring a brightness value of each region of the main image area when the flash pre-flashing. The flash-intensity calculating module is configured for calculating a mean value according to the brightness value of each region to obtain a flash intensity value for the flash unit. The flash drive device is configured for driving the flash unit to flash according to the flash intensity value.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of exemplary embodiments thereof and with reference to the accompanying drawings, in which:

FIG. 1 is a block diagram of a flash intensity adjusting device according to one exemplary embodiment of the present invention;

FIG. 2 is an image presented as an example to explain work principle of the flash intensity adjusting device of FIG. 1;

FIG. 3 is a schematic view of a main image area selected from the image of FIG. 2, further partitioning it into 64 regions; and

FIG. 4 is a flow chart of an exemplary adjusting method utilizing the flash intensity adjusting device of FIG. 1.

### DETAILED DESCRIPTION OF EXEMPLARY EMBODIMENTS

A detailed explanation of a flash intensity adjusting device according to an exemplary embodiment of the present invention will now be made with reference to the drawings attached hereto.

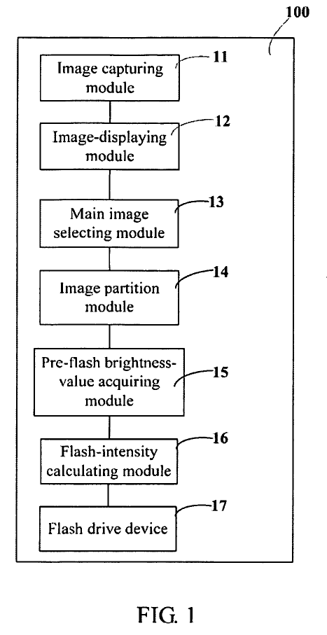

Referring to FIGS. 1 through 3, a flash intensity adjusting device 100 according to the exemplary embodiment is shown. The flash intensity adjusting device 100 includes an image capturing module 11, an image-displaying module 12, a main image selecting module 13, an image partition module 14, a pre-flash brightness-value acquiring module 15, a flash-intensity calculating module 16, and a flash drive device 17.

It should be noted that the flash intensity adjusting module 1 00 is employed in an imaging device, such as digital still camera, video camera, and so on that utilizes a flash unit (not shown). The imaging device includes a central processing unit (CPU) typical of conventional digital cameras. The CPU is electronically connected to the flash intensity adjusting device 100 and performs the general control of the various operations of the imaging device including a capturing operation, an automatic focusing (AF) operation, an automatic exposure operation, a flash operation etc. In the present embodiment, the CPU is configured for cooperating with each module of the flash intensity adjusting device 100.

It should be noted that the flash unit can be an LED flash, a xenon flash, or the like. The flash unit may include pre-flash light emission for reducing a common phenomenon known as red-eye and a main flash emission for illuminating the object during flash assisted image capturing.

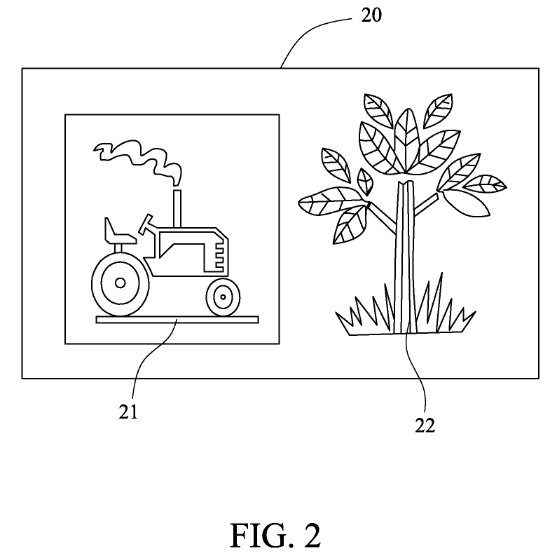

The image capturing module 11 can be a camera module having an image capture device, such as a CCD image sensor, a CMOS image sensor, or the like, and is configured for capturing an image 20 shown in FIG. 2 of the object. In the present embodiment, the image 20 including a tractor 21 and a tree 22 is presented only as an example to explain working principles of the flash intensity adjusting device 100. In the present embodiment, it is assumed that the tractor 21 is a main image area of interest, and so flash intensity should be adjusted for the tractor 21.

The image-displaying module 12 may include a touch screen for displaying the image captured by the image capturing module 11. Understandably, the image displaying module 1 2 is still used for displaying other information, such as, status of the digital camera 100, or the like. It should be noted that a “touch” on a typical touch screen means that the touch screen of the image-displaying module 12 senses the location of the touch of an object such as a tip of a finger or another object (not shown), for example a stylus on an active surface area of the touch screen.

The main-image selecting module 13 is configured for selecting a main image area from the image-displaying module 12. The main image area is selected from the touch screen of the image-displaying module 12 by the user. In the present embodiment, the main image area is the area of the image encompassing the tractor 21.

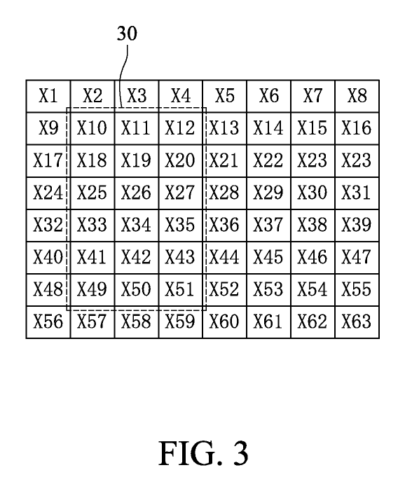

The image partition module 14 is configured for partitioning the tractor 21 into at least two regions. In the present embodiment, the tractor 21 is partitioned into 64 regions, named matrix 30, shown in FIG. 3.

The pre-flash brightness-value acquiring module 15 is configured for acquiring a brightness value of each region of the tractor 21 prior to using the flash unit. The flash unit provides the pre-flash light emission before the shutter opens to make an exposure. The pre-flash light emission causes the pupils in the eyes of the person being photographed to contract, and it precedes the shutter opening and the main flash light emission by a time delay such as 0.35-0.75 seconds. This time delay is sufficient to ensure the acquiring of the brightness-value of each region and calculation of a mean value of the brightness-values by the flash-intensity calculating module 16.

The flash-intensity calculating module 16 is configured for calculating a mean value according to the brightness value of each region of matrix 30 to obtain a flash intensity value of the flash. The mean value is calculated using the following formula:

T=(V(X₁)+V(X₂)+ . . . +V(Xₙ))/n

wherein:
V(Xₙ) is a brightness value of a region;
T is a mean value of a number of regions; and
n is a quantity of regions of matrix 30 detected.

The imaging device further includes a flash drive device configured for driving the flash to flash according to the flash intensity value. The flash drive device may be a circuit connected to the CPU. The CPU controls the voltage supplied for the flash drive device according to the flash intensity value to control the brightness of light emitted from the flash.

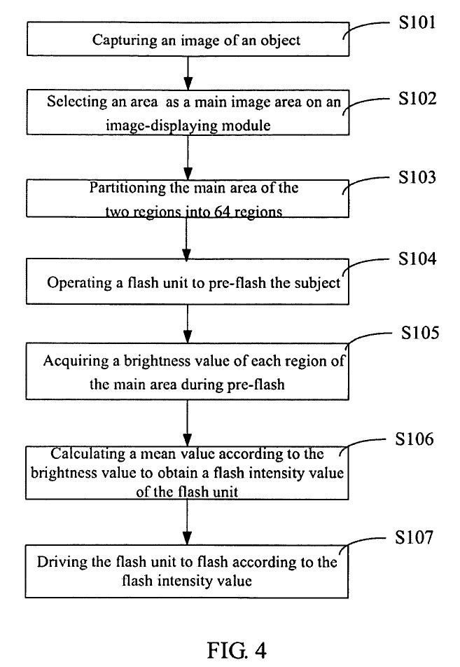

Referring to FIG. 4, a flow chart of an exemplary method for adjusting the flash intensity value is shown. The method includes:
step S101: capturing a pre-image 20 of the object;
step S102: selecting the tractor 21as a main image area on an image-displaying module 12;
step S103: partitioning the tractor 21 into 64 regions;
step S104: operating the flash unit to pre-flash the object;
step S105: acquiring a brightness value of each region of the tractor 21 during pre-flash;
step S106: calculating a mean value according to the brightness values to obtain a flash intensity value of the flash; and
step S107: capturing an image of the object using the flash unit according to the flash intensity value calculated in step S106.

As a result, the flash intensity adjusting device 100 can acquire a appropriate flash intensity for the main image area and drive the flash to flash according to the flash intensity value. Therefore, the main image area can obtain an optimal brightness value.

It should be understood that the above-described embodiment is intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A flash intensity adjusting device employed in an imaging device for adjusting flash intensity of a flash unit when highlighting an object, comprising:
an image capturing module configured for capturing an image;
an image-displaying module configured for displaying the image captured by the image capturing module;
a main-image selecting module configured for selecting a main image area from the image-displaying area;
an image partition module configured for partitioning the main image area into at least two regions;
a pre-flash brightness-value acquiring module configured for acquiring a brightness value of each region of the main image area during pre-flash;
a flash-intensity calculating module configured for calculating a mean value according to the brightness value of each region to obtain a flash intensity value of the flash unit; and
a flash drive device configured for driving the flash unit to flash according to the flash intensity value.

2. The flash intensity adjusting device as claimed in claim 1, wherein the image-displaying module comprises a touch screen configured for selecting the main image area by the main-image selecting module.

3. The flash intensity adjusting device as claimed in claim 1, wherein the image capturing module comprises a CCD image sensor.

4. The flash intensity adjusting device as claimed in claim 1, wherein the image capturing module comprises a CMOS image sensor.

5. The flash intensity adjusting device as claimed in claim 1, wherein the mean value is calculated using the following formula:
T=(V(X₁)+V(X₂)+ . . . +V(Xₙ))/n,
wherein,
V(Xₙ) is the brightness value of region n;
T is the mean value of brightness for the regions; and
n is the number of regions.

6. A method for adjusting a flash intensity of a flash employed in an imaging device comprising an image-displaying area, comprising:
capturing an image of an object;
selecting a main image area from the image-displaying area of the imaging device;
partitioning the image into a plurality of regions;
operating the flash to pre-flash the object;
acquiring a brightness value of each region of the main image area during pre-flash;
calculating a mean value according to the brightness values to obtain a flash intensity value of the flash; and
capturing an image of the object using the flash unit according to the flash intensity value.

7. The method as claimed in claim 6, wherein the mean value is calculated using the following formula:
T=(V(X₁)+V(X₂)+ . . . +V(Xₙ))/n,
wherein,
V(Xₙ) is the brightness value of region n;
T is the mean value of brightness for the regions; and
n is the number of regions.
